(19) United States
(12) Patent Application Publication
(10) Pub. No.: US 2022/0307638 A1
(43) Pub. Date: Sep. 29, 2022

(54) TWO FLOW, SUBSEA, HYDROCARBON FLUID FLOW PATH CONNECTING CONCENTRIC HUB AND USE OF SUCH A HUB

(71) Applicant: Vecto Gray Scandinavia AS, Nailsea (GB)

(72) Inventor: Steinar Lindemann HESTETUN, Hovik, Akershus (NO)

(21) Appl. No.: 17/597,176

(22) PCT Filed: Jul. 1, 2020
(86) PCT No.: PCT/EP2020/025309

§ 371 Date: Dec. 28, 2021

(30) Foreign Application Priority Data
Jul. 1, 2019 (NO) 20190819

(51) Int. Cl. F16L 39/00; E21B 43/013; E21B 43/01

(52) U.S. Cl. CPC F16L 39/005; E21B 43/013; E21B 43/0107

(57) ABSTRACT

The present invention concerns a two flow, hydrocarbon production fluid flow path connecting concentric hub. The hub comprises a first and second end sections, each with a concentric port, a concentric inner flow path forming a part of an inner flow path and a side port forming a part of an outer flow path in an annulus surrounding the inner flow path. A female and a male coupling section, each with an inner cylindrical flow section form a part of the concentric inner flow path, and female and male coupling section outer parts surrounding the female and the male coupling section inner cylindrical flow section form a part of the outer flow path in the annulus surrounding the concentric inner flow path. A sealing surface is located between the male coupling section and the female coupling section. The invention also concerns use of the above concentric hub.

The present invention relates to a two flow, subsea, hydrocarbon fluid flow path connecting concentric hub. The concentric dual flow path connection used to step out a flowline to a pump, compression station or a separator station by one jumper. It can also be used as a dual flow path connection to a manifold or similar elements.

The advantage with the concentric design is to avoid rotation tolerances on a jumper and torsion due to rotation misalignment.

The design of the present invention solves the problem with rotation tolerances on the jumper and torsion due to rotation misalignment. Furthermore, the design allow large equal flow path area dual jumpers, without introducing torsion to the pipe. The design replaces pipe, hub and valve body with one unit. With the present invention welding in situ can be avoided.

The hub will fit into both a standard vertical and a standard horizontal connection system. The hubs are fitted with a pipe in pipe section that allow the configuration to fit the alignment system design.

The present invention concerns a two flow, hydrocarbon production fluid flow path connecting concentric hub. The hub comprises a first end section with a first concentric port, a concentric inner flow path forming a part of an inner flow path and a first side port forming a part of an outer flow path in an annulus surrounding the inner flow path. A second end section with a second concentric port and the concentric inner flow path form a part of the inner flow path. A second side port form a part of the outer flow path in the annulus surrounding the inner flow path. A male coupling section with a male coupling section inner cylindrical flow section form a part of the concentric inner flow path, and a male coupling section outer part surrounding the male coupling section inner cylindrical flow section forming a part of the outer flow path in the annulus surrounding the concentric inner flow path. A female coupling section with a female coupling section inner cylindrical flow section form a part of the concentric inner flow path and a female coupling section outer part surrounding the female coupling section inner cylindrical flow section form a part of the outer flow path in the annulus surrounding the concentric inner flow path. A sealing surface is located between the male coupling section inner cylindrical flow section and the female coupling section inner cylindrical flow section. A sealing surface is located between the male coupling section outer part and the female coupling section outer part. The first end section, the second end section, the male coupling section and the female coupling section are in fluid connection and form the concentric inner flow path and the surrounding annular outer flow path.

The two flow, subsea, hydrocarbon fluid flow path connecting concentric hub defined above may further include an inner tube forming a part of the inner flow path and an outer tube forming a part of the outer annular flow path between at least one of the first and second end sections and one of the female and male coupling sections whereby the inner tube and the outer tube form a tube in tube.

The first and second end sections and the female and male coupling sections may each include an inner ring shaped connecting surface and an outer ring shaped connecting surface, each adapted to be welded to an adjoining element.

The inner flow path define an inner flow path cross sectional area and the outer flow path define an outer flow path cross sectional area that may be equal to the inner flow path cross sectional area.

The outer cross sectional area may be maintained through the first and second side ports.

The male coupling section may include a protruding ring and the female coupling section may include a complementary ring shaped recess for the protruding ring.

The male coupling section may include a male coupling section outer flange surrounding and the female coupling section may include a female coupling section outer flange surrounding the female coupling section to allow a clamp to hold the coupling sections in a sealing contact.

The two flow, subsea, hydrocarbon fluid flow path connecting concentric hub described above may include a clamp connector holding the male coupling section to the female coupling section.

The present invention furthermore concerns use of a two flow, hydrocarbon production fluid flow path connecting concentric hub as described above to connect a pipeline to a module through an inline tee.

The module may be a compression module.

### BRIEF DESCRIPTION OF THE DRAWINGS

FIG. 1 is a schematic representation of a typical connection of a module to a pipeline with an inline tee (ILT) according to the prior art;

FIG. 2 is a schematic representation of a typical connection of a module to a pipeline with an inline tee (ILT) according to the present invention;

FIG. 3 shows a cross-section of a large and equal flow path two-flow connecting, concentric hub of the invention;

FIG. 4 shows the outline of the large and equal flow path concentric hub configuration as shown on FIG. 3;

FIG. 5 is a cross section of the coupling portion along line A-A of FIG. 3.

FIG. 6 is a cross section of an embodiment of the invention omitting a pipe in pipe and including connecting pipes welded to first and second end sections; and

FIG. 7 is a cross section of a large flow path concentric hub configuration of the invention and a clamp connector, clamping the male and female coupling sections together.

### DETAILED DESCRIPTION OF AN EMBODIMENT OF THE INVENTION WITH REFERENCE TO THE ENCLOSED DRAWINGS

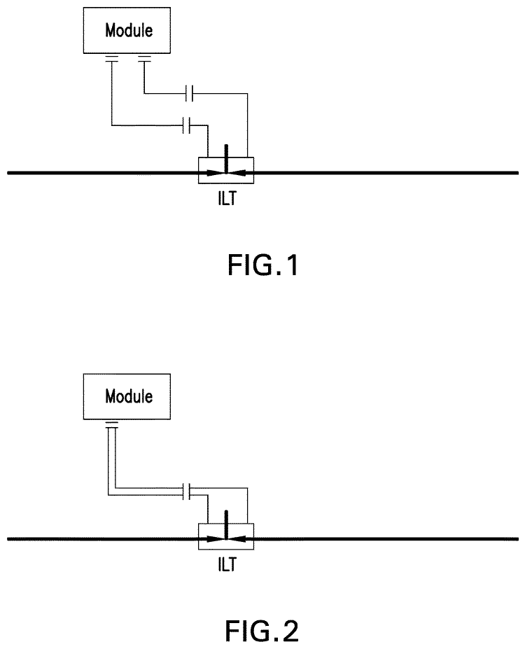

FIG. 1 shows a typical connection of a module to a pipeline with an inline tee (ILT) according to the prior art. Two separate jumpers with connectors connect the module and the ILT resulting in two separate connecting operations (provided the jumpers are already connected to the module or the ILT).

FIG. 2 shows a connection of a module to a pipeline with an inline tee (ILT) according to the invention. A large flow path concentric hub configuration enables a module, typically a compression module, to be connected to an ILT with just one connecting operations while maintaining two fluid paths between the module, ILT and thus the pipeline. (provided the pipe in pipe jumper is already connected to the module or the ILT.

The large flow path concentric hub configuration 1 of the invention includes two parts connected with a coupling.

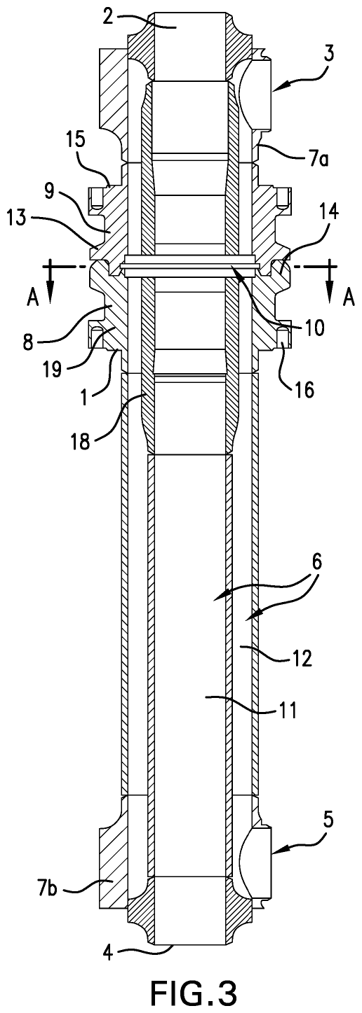

FIG. 3 shows the large and equal flow path concentric hub configuration 1 of the invention. A second end section 7b is secured to a second end of a tube in tube 6 defining an inner flow path 11 and an outer flow path 12. A first end section 7a is secured to a male coupling section 9. Each end section 7 includes an inlet and an outlet.

The inlets and the outlets have equal cross sectional area or flow area and are thus designed for the same volume flow. The second end section 7b includes a concentric port 4 for the inner flow path 11 and a side port 5 for the outer flow path 12. The ports 4, 5 are of the same size.

Similarly, the first end section 7a includes a concentric port 2 for the inner flow path 11 and a side port 3 for the outer flow path 12. The ports 2, 3 are of the same size.

A female coupling section 8 is secured to a second end of the tube in tube 6. The male and female coupling sections 8, 9 include at least an outer sealing surface 10 sealing against ingress of water or leakage of the fluid inside the outer flow path and the exterior of the coupling and an inner sealing, sealing between the inner and outer flow path to prevent mixing of the fluids inside the coupling. The outer surface also include a protruding ring on the male part 9 and a complementary ring shaped recess for the protruding ring in the female part 10 to ensure alignment of the hub parts. The protruding ring and the complementary ring shaped recess may also contribute to the sealing between the hub parts.

A male coupling section outer flange 13 surrounds the male coupling section 9 and a female coupling section outer flange 14 surrounds the female coupling section 8 to allow a clamp to hold the coupling sections in a sealing contact.

The end sections 7, the male coupling section 9 and the female coupling section 8, all include an outer part with an outer ring shaped connecting portion, an annular flow section and an inner tubular part with an inner ring shaped connecting portion and an inner cylindrical flow section. The annular flow section is formed between the interior of the outer part and the exterior of the inner tubular part. Connecting ribs hold outer hub part concentrically to the inner tubular hub part.

An attachment flange 15 on each of the male and female coupling sections 8, 9 include bolt holes 16 allowing the male and female coupling sections 8, 9 to be secured to suitable sections or to elements facilitating connection or gripping of an ROV.

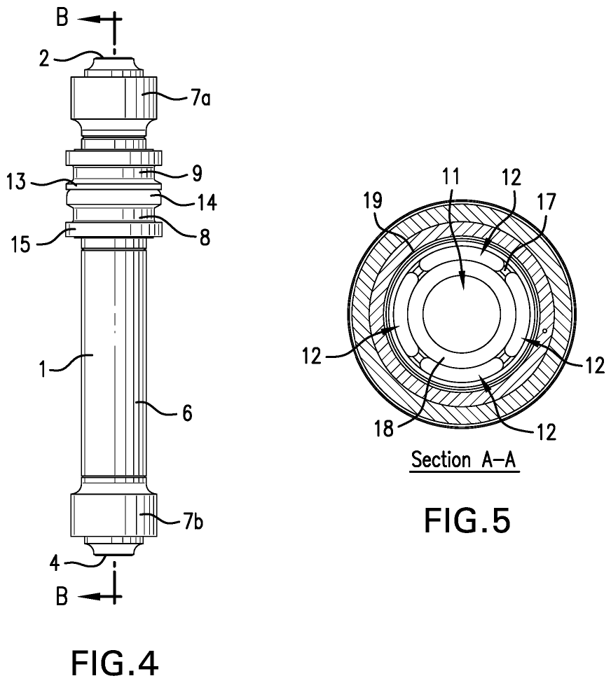

FIG. 4 shows the outline of the large and equal flow path concentric hub configuration 1 as shown on FIG. 3. The second end section 7b includes the concentric port 4 for the inner flow path and the first end section 7a includes a concentric port 2 for the inner flow path. The tube in tube 6 is secured to the second end section 7b and the female coupling section 8. The male coupling section 9 is welded directly to the second end section 7.

FIG. 5 is a cross section of the coupling portion along line A-A of FIG. 3. The inner flow path 11 and the outer flow path 12 have equal cross sectional area and are thus designed for the same flow rate. The four connecting ribs 17 hold the inner cylindrical flow section 18 to the outer part 19 of the male coupling section 9 and the female coupling section 8.

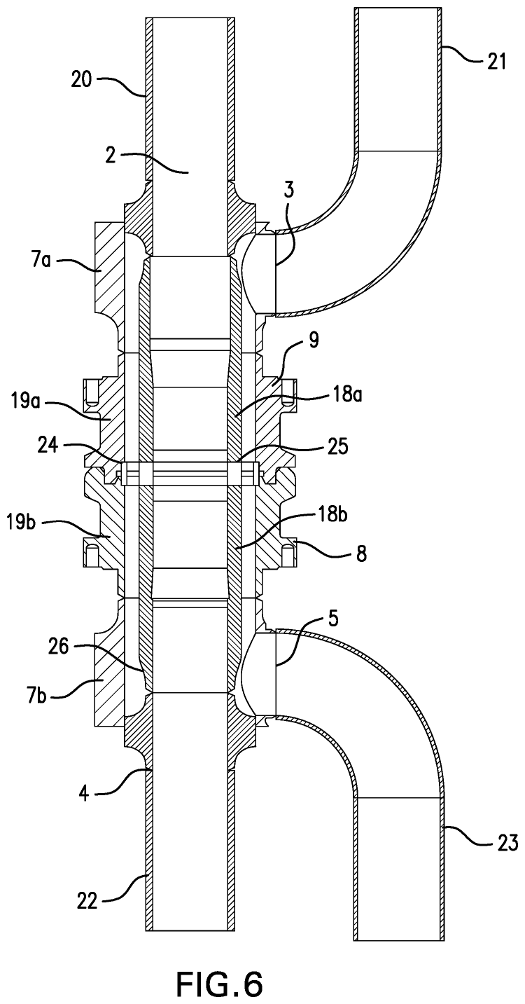

FIG. 6 shows the solution of FIGS. 3, 4 and 5, apart from omitting the pipe in pipe. Additionally, FIG. 6 shows connecting pipes welded to the first and the second end sections 7, and how the end sections leads the flow from the concentric elements to two connecting pipes while maintaining the same cross section or flow area.

The first end section 7a is welded to a first concentric pipe 20, covering the first concentric port 2. Furthermore, the first end section 7a is welded to a first side pipe 21, covering the first side port 3.

Similarly, the second end section 7b is welded to a second concentric pipe 22, covering the second concentric port 4. Furthermore, the second end section 7b is welded to a second side pipe 23, covering the second side port 5.

An outer annular seal 24 seals between the outer parts 19a, 19b of the male and female coupling sections 9, 8 and an annular inner seal 25, seals between the inner cylindrical flow sections 18 of the male and female coupling sections 9, 8. The outer annular seal 24 and the annular inner seal 25 is formed in one piece with ports allowing fluid too flow in the annulus and in the centre.

An increased cross section transition area 26 (formed as a reduction of the outer diameter of the inner cylindrical flow sections 18) of the annulus in the area of the first and second side ports 3, 5, ensures that there are no restrictions in the flow area out of the first and second side ports 3, 5.

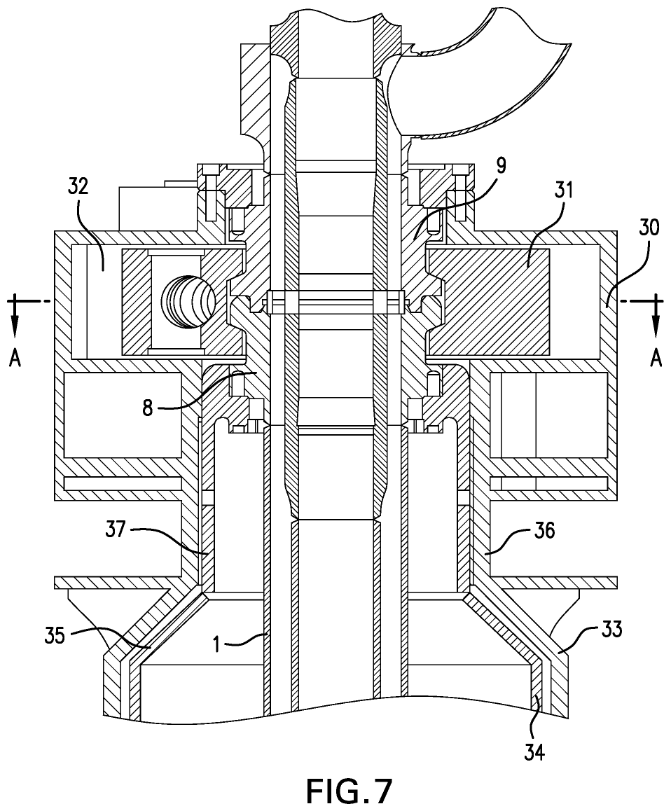

FIG. 7 shows the large flow path concentric hub configuration 1 of the invention and a clamp connector 30, clamping the male coupling section 9 to the female coupling section 8. The clamp connector includes a guiding funnel 33 facilitating connection of the coupling sections. Clamp elements 31 are movable between a forward locking position and a retracted releasing position inside a clamp element cavity 32. The clamp connector 30 is bolted to the male coupling section 9 and a guiding, stress alleviating and aligning connection element 34 is bolted to the female coupling section 8. The guiding, stress alleviating and aligning connection element 34 includes an externally cylindrical portion 37 and an externally conical portion 35 fitting into an internally cylindrical portion 36 and the internally conical guiding funnel 33 of the clamp connector 30.

The system can be used for all flow path sizes, typically 2×4″, 2×6″, 2×8″, 2×10″ or 2×12″. The maximum size is restricted by the hub size.

The present specification concerns a two flow, hydrocarbon production fluid flow path connecting concentric hub. The term “hydrocarbon production fluid” is intended to cover any fluid flowing in connection the exploration and production of hydrocarbons and includes produced water and injected water and other substances. Fluids are produced by a hydrocarbon well and fluids that are injected into a hydrocarbon well. The term “hydrocarbon well” is intended to cover a well used in connection with the production of hydrocarbons, but not necessarily a well that actually produces hydrocarbons and should cover pure injection wells.

1-10. (canceled)

11. A two flow, hydrocarbon production fluid flow path connecting concentric hub comprising a first end section with a first concentric port, a concentric inner flow path forming a part of an inner flow path and a first side port forming a part of an outer flow path in an annulus surrounding the inner flow path;
a second end section with a second concentric port and the concentric inner flow path forming a part of the inner flow path, a second side port forming a part of the outer flow path in the annulus surrounding the inner flow path;
a male coupling section with a male coupling section inner cylindrical flow section forming a part of the concentric inner flow path, and a male coupling section outer part surrounding the male coupling section inner cylindrical flow section forming a part of the outer flow path in the annulus surrounding the concentric inner flow path;
a female coupling section with a female coupling section inner cylindrical flow section forming a part of the concentric inner flow path and a female coupling section outer part surrounding the female coupling section inner cylindrical flow section forming a part of the outer flow path in the annulus surrounding the concentric inner flow path;
a sealing surface between the male coupling section inner cylindrical flow section and the female coupling section inner cylindrical flow section;
a sealing surface between the male coupling section outer part and the female coupling section outer part; and
wherein the first end section, the second end section, the male coupling section and the female coupling section are in fluid connection and form the concentric inner flow path and the surrounding annular outer flow path.

12. The two flow, subsea, hydrocarbon fluid flow path connecting concentric hub of claim 11, further including an inner tube forming a part of the inner flow path and an outer tube forming a part of the outer annular flow path between at least one of the first and second end sections and one of the female and male coupling sections whereby the inner tube and the outer tube form a tube in tube.

13. The two flow, subsea, hydrocarbon fluid flow path connecting concentric hub of claim 11, wherein the first and second end sections and the female and male coupling sections each include an inner ring-shaped connecting surface and an outer ring-shaped connecting surface, each adapted to be welded to an adjoining element.

14. The two flow, subsea, hydrocarbon fluid flow path connecting concentric hub of claim 11 wherein the inner flow path define an inner flow path cross sectional area and the outer flow path define an outer flow path cross-sectional area equal to the inner flow path cross sectional area.

15. The two flow, subsea, hydrocarbon fluid flow path connecting concentric hub of claim 14, wherein the outer cross-sectional area is maintained through the first and second side ports.

16. The two flow, subsea, hydrocarbon fluid flow path connecting concentric hub of claim 11 wherein the male coupling section includes a protruding ring and the female coupling section includes a complementary ring-shaped recess for the protruding ring.

17. The two flow, subsea, hydrocarbon fluid flow path connecting concentric hub of claim 11 further including a male coupling section outer flange surrounding the male coupling section and a female coupling section outer flange surrounding the female coupling section to allow a clamp to hold the coupling sections in a sealing contact.

18. The two flow, subsea, hydrocarbon fluid flow path connecting concentric hub of claim 11 further including a clamp connector holding the male coupling section to the female coupling section.

19. A use of a two flow, hydrocarbon production fluid flow path connecting concentric hub of claim 11 to connect a pipeline to a module through an inline tee.

20. The use according to claim 19, wherein the module is a compression module.
